(19) United States
(12) Patent Application Publication
(10) Pub. No.: US 2015/0161127 A1
(43) Pub. Date: Jun. 11, 2015

(54) RANKING ENTITY REALIZATIONS FOR INFORMATION RETRIEVAL

(71) Applicant: Google Inc., Mountain View, CA (US)

(72) Inventors: Samuel C. Oates, Cambridge, MA (US); Matthew K. Gray, Reading, MA (US)

(73) Assignee: Google Inc.

(21) Appl. No.: 13/765,975

(22) Filed: Feb. 13, 2013

Related U.S. Application Data
(60) Provisional application No. 61/598,133, filed on Feb. 13, 2012.

(51) Int. Cl. G06F 17/30

(52) U.S. Cl. CPC G06F 17/3053

(57) ABSTRACT

Methods, systems, and apparatus, including computer programs encoded on a computer storage medium, for identifying and ranking entities for reference as search results. In one aspect, a method includes receiving data identifying resources that are relevant to a query. The data for each resource can include a relevance score, a list of references to entity realizations included in the resource, and for each reference to an entity realization in the list, one or more resource reference scores. For each resource and for each reference to an entity realization in the resource, a partial score for the reference can be determined from the resource reference scores for the reference and the relevance score for the resource. For each reference to an entity realization, a reference score for the reference is determined from each of the partial scores for the reference. Search results can be ranked based on the reference scores.

### CROSS-REFERENCE TO RELATED APPLICATION

This application claims priority to U.S. Provisional Application No. 61/598,133, filed on Feb. 13, 2012, entitled “RANKING ENTITY REALIZATIONS FOR INFORMATION RETRIEVAL,” the entire contents of which is hereby incorporated by reference.

### BACKGROUND

This specification relates to information retrieval.

The Internet provides access to a wide variety of resources, such as image files, audio files, video files, electronic books, and web pages. A search system can identify resources in response to a text query that includes one or more search terms or phrases. One type of search includes a search for books. A search system can access a book corpus and identify books that are relevant to a query.

The search system can rank the books based on their relevancy to the search query and provide search results that link to web pages related to the books. For example, the search system may rank the books based on information retrieval (“IR”) scores for the books with respect to the query. The search results are typically ordered for viewing according to the rank.

Often a search engine may provide search results that do not fully satisfy a user's informational need. Search engines may provide such results for a number of reasons, such as the query including terms that are a poor expression of the user's informational need, or the user not being fully aware of the scope of the content the user is searching. Furthermore, in the context of a book corpus, the search results that are returned may omit certain books or passages that may be of interest to the user, as the collective content of the book corpus mostly comprises expressions of certain works. As used in this specification, the term “expression” is defined in the Functional Requirements for Bibliographic Records. In particular, an expression is “the specific intellectual or artistic form that a work takes each time it is ‘realized.’” A work is “a distinct intellectual or artistic creation.” For example, the English edition of Tom Sawyer the novel is an expression of the work “Tom Sawyer” authored by Mark Twain. Likewise, a graphic novel of “Tom Sawyer” is another expression of the work “Tom Sawyer.”

Thus, unless a user is aware of certain expressions or works, the user may submit queries that do not result the identification of resources that reference expressions or works. Accordingly, the user's informational need may not be fully satisfied, and, in cases in which the user is unaware of certain expressions and works, the user may not even realize that there exists additional information that may be of interest to the user.

### SUMMARY

In general, one innovative aspect of the subject matter described in this specification can be embodied in methods that include the actions of receiving data identifying resources that are determined to be relevant to a query, the data including, for each resource: a relevance score that is a measure of relevance of the resource to the query; a list of references to entity realizations included in the resource, each reference being a reference to a particular entity realization; and for each reference to an entity realization in the list, one or more resource reference scores that are a measure of a quality of the reference in a context of the resource; for each resource and for each reference to an entity realization in the resource, determining a first partial score for the reference from the one or more resource reference scores for the reference and the relevance score for the resource; for each reference to an entity realization, determining a reference score for the reference from each of the first partial scores for the reference; and adjusting an order of search results that each reference a resource that is determined to be responsive to the query based on reference scores. Other embodiments of this aspect include corresponding systems, apparatus, and computer programs, configured to perform the actions of the methods, encoded on computer storage devices.

These and other embodiments can each optionally include one or more of the following features. Each entity realization can be an expression. The expression can be a specific intellectual or artistic form of a realization of a distinct intellectual creation. Each entity realization can be a name of a person.

Determining the first partial score for the reference from the one or more resource reference scores for the reference and the relevance score for the resource can include determining, for the resource, a second partial score from one or more resource reference scores of each reference included in the resource; and determining, for the reference, the first partial score from the one or more resource reference scores for the reference, the relevance score for the resource, and the second partial score for the resource.

For each reference, the one or more resource reference scores can include: a confidence score that is a measure of confidence that the reference actually references the expression; and a topicality score that is a measure of the topical relatedness of the expression to content of the resource. Determining, for the resource, the second partial score from one or more resource reference scores of each reference included in the resource can include: for each reference included in the resource, determining a first value proportional to a product of the confidence score and the topicality score; and summing the first values determined for each reference included in the resource.

Determining, for the reference, the first partial score from the one or more resource reference scores for the reference, the relevance score for the resource, and second partial score for the resource can include determining, for the reference, a second value proportional to the first value divided by the relevance score for the resource; and determining, for the reference, the first partial score in proportion to the second value divided by the second partial score.

Determining the reference score for the reference from each of the first partial scores for the reference can include summing the first partial scores determined for the reference for each of the resources that include the reference; and determining the reference score in proportion to a product of the sum of the first partial scores and a relevance score of one of the resources.

The relevance score of one of the resources can be a relevance score of a resource in an Nth ordinal position when the resources are ordered in a rank according to their respective relevance scores. The relevance score can be the ordinal position.

Determining, for the reference, the first partial score from the one or more resource reference scores for the reference, the relevance score for the resource, and second partial score for the resource can include: for each reference included in the resource, determining a first value proportional to the one or more resource reference scores; and summing the first values determined for each reference included in the resource.

Determining the reference score for the reference from each of the first partial scores for the reference can include summing the first partial scores determined for the reference for each of the resources that include the reference; and determining the reference score in proportion to a product of the sum of the first partial scores and a relevance score of one of the resources.

The relevance score of one of the resources can be a relevance score of a resource in an Nth ordinal position when the resources are ordered in a rank according to their respective relevance scores.

Another innovative aspect of the subject matter described in this specification can be embodied in methods that include the actions of receiving data identifying entity realizations; for each identified entity realization: receiving data identifying resources that include a reference to the entity realization, the data including, for each resource, a quality score for the resource, the quality score being a measure of quality of the resource relative to other resources in a resource corpus; for each of the resources, receiving data defining one or more resource reference scores that are a measure of a quality of the reference included in the resource in a context of the resource; ranking the resources based at least in part on the one or more resource reference scores and the quality scores of the resources to determine a rank order for the resources; selecting a set of resources, the set of resources being up to N top ranked resources according to the rank order for the resources; and associating the selected set of resources with the entity realization. Other embodiments of this aspect include corresponding systems, apparatus, and computer programs, configured to perform the actions of the methods, encoded on computer storage devices.

These and other embodiments can each optionally include one or more of the following features. Each entity realization can be an expression. The expression can be a specific intellectual or artistic form of a realization of a distinct intellectual creation.

Ranking the resources based at least in part on the one or more resource reference scores and the quality scores of the resources to determine a rank order for the resources can include determining, for each resource, a rank score proportional to a product of the one or more resource reference scores and the quality score for the resource; and ranking the resources based on the rank scores of the resources.

The one or more resource reference scores can include a confidence score that is a measure of confidence that the reference actually references the entity realization. Determining, for each resource, a rank score proportional to a product of the one or more resource reference scores and the quality score for the resource can include determining a rank score that is proportional to a product of the confidence score and the quality score.

For each reference, the one or more resource reference scores can include a topicality score that is a measure of the topical relatedness of the entity realization to content of the resource. Determining, for each resource, a rank score proportional to a product of the one or more resource reference scores and the quality score for the resource can include determining a rank score that is proportional to a product of the topicality score and the quality score.

For each reference, the one or more resource reference scores can further include a confidence score that is a measure of confidence that the reference actually references the entity realization. Determining, for each resource, a rank score proportional to a product of the one or more resource reference scores and the quality score for the resource can include determining a rank score that is proportional to a product of the confidence score, the topicality score and the quality score.

At least one resource defines an intersecting set of at least two of the selected sets.

Aspects can further include generating a union of the associated sets; receiving data identifying resources that are determined to be relevant to a query, each of the resources being a member of the union of the associated sets, the data including, for each resource: a relevance score that is a measure of relevance of the resource to the query; a list of references to entity realizations included in the resource, each reference being a reference to a particular entity realization; and for each reference to an entity realization in the list, one or more resource reference scores that are a measure of a quality of the reference in a context of the resource; for each resource and for each reference to an entity realization in the resource, determining a first partial score for the reference from the one or more resource reference scores for the reference and the relevance score for the resource; for each reference to an entity realization, determining a reference score for the reference from each of the first partial scores for the reference; and adjusting an order of search results that each reference a resource that is determined to be responsive to the query based on reference scores. Each entity realization can be an expression, the expression being a specific intellectual or artistic form of a realization of a distinct intellectual creation.

Particular embodiments of the subject matter described in this specification can be implemented so as to realize one or more of the following advantages. Entities, such as book expressions, can be ranked or ordered according to reference score for the entities that are based on non-book corpus resources (e.g., web pages) that include a reference to the entity. The reference scores can be used to more accurately rank book corpus search results that reference the entities, and to surface book results that may have not been identified in response to an original query.

Accordingly, users are presented with information that more fully satisfies the user's informational need. For example, search results that reference an entity having a high reference score can be promoted in a search results ranking. The reference scores can be used to surface entities previously excluded from search results. For example, a synthetic search result may be generated for a book expression having high reference score relative to other book expressions. Offline analysis and processing can be performed for book expressions, for example to improve scan quality of books for expressions having a high reference score. The type of query, e.g., for books or pages of books, can be identified, for example based on the book expressions that having a high reference score for the query.

In some implementations, a proper subset of resources is identified from a web corpus for use in analyzing references to entities in a larger set of resources. The proper subset can be used to rank entities, such as book expression, when searching a corpus of entities. The proper subset is a relatively small set of resources when compared to all indexed resources, and thus the processing resources required to rank expressions is reduced. The dominance of some expressions that are considered relevant to many queries based on the large number of resources that reference the expression can be suppressed in search results, allowing more relevant but less referenced expressions to be ranked higher.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search system provides search services.

FIG. 2 is a flow chart of an example process for ordering search results responsive to a search query.

FIG. 3 is a block diagram of an example data flow for determining a reference score for an entity realization.

FIG. 4 is a flow chart of an example process for determining a reference score for an entity realization.

FIG. 5 is a block diagram of an example data flow for identifying set of resources for entity realizations.

FIG. 6 is a flow chart of an example process for identifying a set of resources for entity realizations.

Like reference numbers and designations in the various drawings indicate like elements.

### DETAILED DESCRIPTION

### §1.0 Overview

A system can rank references to entities or entity realizations in documents in a corpus, and optionally use the ranking of references to adjust positions of search results that are responsive to a query. In some implementations, the entities are book expressions, and the ranking of expressions is accomplished when searching a book corpus in response to a query. The expressions, once ranked, can be used to surface, or promote, book search results.

In some implementations, the query is used to search a general web corpus of resources in addition to the book corpus. In response to the search of the general web corpus, resources that are responsive to the query are identified. Data identifying the resources and a relevance score for each resource is returned to an expression ranking system. The relevance score for a resource is a measure of relevance for the resource to the query. For example, a resource having a relevance score that is higher than the relevance score of another resource is considered more relevant to the query than the other resource. The relevance score can be based on a comparison of the text of the resource to the query, and, optionally, the relative importance of the resource relative to other resources. Other metrics can also be used when determining a relevance score.

The expression ranking system also receives, for each identified resource, a list of references to expressions included in the resource, and for each reference in the resources, a confidence score and a topicality score. The confidence score is a measure of confidence that the reference actually refers to the expression, and the topicality score is a measure of the topical relatedness of the expression to content of the resource. That is, the topicality score for a reference to an expression included in a resource is a measure of relatedness between a topic for the content of the resource and a topic for the expression referenced in the resource. For example, consider a first web page that is directed to a detailed study of a particular book expression and a second web page that is a blog about books an individual has read and that includes a manifestation of the book expression. The topicality score for a reference to the particular book expression with respect to the first web page would likely be higher than the topicality score for a reference to the particular book expression with respect to the second web page.

In some implementations, to rank the expressions, the system generates a score for each resource. The score for a resource, referred to herein as a “resource partial score,” can be a sum of values, where each value is for a particular reference to an expression in the resource. The value for a reference to an expression in a resource can be proportional to a product of the confidence score and the topicality score for the reference to the expression included in the resource. Then, for each expression referenced in the resource, the system determines a partial score for the expression from the resource partial score for the resource, the confidence and topicality scores for the reference to the expression, and the relevance score of the resource. This partial score is referred to herein as a “reference partial score.” After the reference partial scores are determined, the system then determines a reference score for each reference from each of the first partial scores for the reference. The expressions are then ordered according to their respective reference scores.

In some implementations, the search of the general web corpus of resources is constrained to a proper subset of resources in the general web corpus. During a preprocessing stage, the system identifies the proper subset of resources. The system receives a list of expressions, and for each expression that is provided to the system, the system identifies resources that include a reference to the expression. Each resource has an associated quality score that is a measure of quality of the resource relative to other resources. For each resource, the system receives a confidence score that is a measure of confidence that the reference actually references the expression. For each expression, the respectively identified resources are ranked based on the confidence scores of the expression and the quality scores of the resources. Up to the top N ranked resources are then selected for each expression. The selection of resources for each expression is not constrained to disjoint sets, and thus any two sets of selected resources for any two expressions may intersect. A union of the selected resources for all expressions defines the proper subset of resources for the web corpus.

The system features described above are described in more detail in the sections that follow. Although the system and its components are described below in the context of book entities, the system can be used for identifying, scoring, and/or ranking other entities, such as movies, plays, music, people, television programs, or television episodes. Furthermore, the system can be used to identify and rank entities at other levels than the expression level. For example, the system can be configured to identify and rank book manifestations, works, or items.

### §1.1 Example Operating Environment

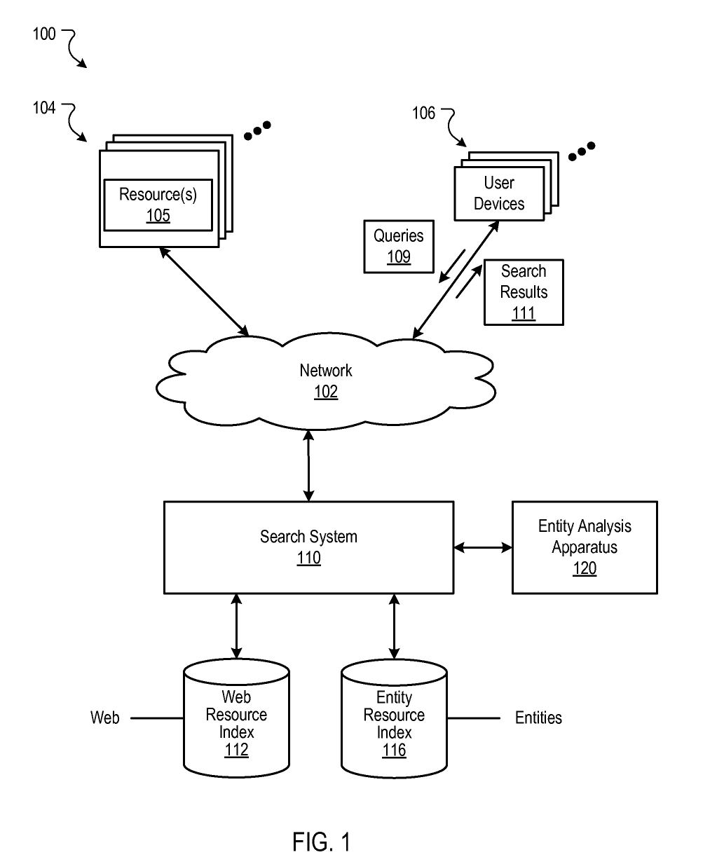

FIG. 1 is a block diagram of an example environment 100 in which a search system 110 provides search services. A computer network 102, such as a local area network (LAN), wide area network (WAN), the Internet, a mobile phone network, or a combination thereof, connects web sites 104, user devices 106, and the search system 110. The environment 100 may include many thousands of web sites 104 and user devices 106.

A web site 104 is one or more resources 105 associated with a domain name and hosted by one or more servers. An example web site 104 is a collection of web pages formatted in hypertext markup language (HTML) that can contain text, images, multimedia content, and programming elements, such as scripts. Each web site 104 is maintained by a publisher, e.g., an entity that manages and/or owns the web site.

A resource 105 is any data that can be provided by a web site 104 over the network 102 and that is associated with a resource address. Resources 105 include HTML pages, word processing documents, book documents, portable format (PDF) documents, images, video, and feed sources, to name just a few. The resources 105 can include content, such as words, phrases, images, and sound, and may include embedded information (e.g., meta information and hyperlinks) and/or embedded instructions (e.g., JavaScript scripts).

A user device 106 is an electronic device that is under control of a user and is capable of requesting and receiving resources 105 over the network 102. Example user devices 106 include personal computers, mobile communication devices, televisions having a processor or that are in communication with a processor, and other devices that can send and receive data over the network 102. A user device 106 typically includes a user application, such as a web browser, to facilitate the sending and receiving of data over the network 102.

### §1.2 Search Processing

To facilitate searching of resources 105, the search system 110 identifies the resources 105 by crawling and indexing the resources 105 provided on web sites 104. Data about the resources 105 can be indexed based on the resource 105 to which the data corresponds. The indexed and, optionally, cached copies of the resources 105 are stored in a web resource index 112. The contents of the web resource index 112 can be considered a web corpus. In some implementations, the web resource index 112 is divided into two separate portions. A first portion may include the crawled and indexed web resources, while a second portion of the web resource index 112 may include a proper subset of the resources determined to be relevant to book expressions, as discussed in more detail below. In some implementations, the web resource index 112 includes data identifying the proper subset of the resources.

The system 100 also includes an entity resource index 116 that stores data about works, expressions, and/or manifestations of specific entities or entity realizations. In some implementations, the entity resource index 116 is a book index, and includes data about book expressions. For example, the entity resource index 116 may include, for each of a multitude of books, scanned pages of the book. The entity resource index 116 may also include metadata about each book expression, such as the publisher, author, copyright date, editions, volumes, variations, and purchasing information. In some implementations, the entity resource index 116 may include information about other types of entities, such as movies, plays, music, or people, to name a few. While two resource indexes 112 and 116 are illustrated in FIG. 1 and described herein, the indexes 112 and 116 can be implemented in single index or in more than two indexes in certain implementations.

A user device 106 can submit a search query 109 to the search system 110. The search system 110 performs a search operation that uses the search query 109 as input to identify resources 105 and/or books responsive to the search query 109. In some implementations, the search system 110 can provide search results for general search queries and/or search results for queries directed to specify entities, such as book expressions. For general search queries, the search system 110 may access the indexed cache 112 to identify resources 105 that are relevant to the search query 109. The search system 110 identifies the resources 105, generates search results 111 that identify the resources 105, and returns the search results 111 to the user devices 106.

For queries directed to books, the search system 110 may access the entity resource index 116 to identify books that are relevant to the query 109. The books can be ranked based on scores related to the books identified by the search system 110, such as information retrieval (“IR”) scores, and optionally a score of each book relative to other books.

The search system 110 may include, or be in data communication with, an entity analysis apparatus 120 to identify additional books or book expressions for referencing as search results and/or to rank book search results, as discussed in more detail below. The search system 110 can generate search results 111 that identify the books, and return the search results to the user device 106. The search results 111 may be provided to the user device 106 according to the ranking.

In some implementations, the search system 110 provides search results for resources 105 and search results for books in response to a received query. For example, the search system 110 may detect that a general search query 109 is possibly directed to books, such as a general query for “Tom Sawyer.” The search system 110 may identify resources 105 and books that are responsive to the query 109, generate search results 111 that identify the resources 105 and search results 111 that identify the books, and return the search results 111 to the user device 106.

As used herein, a search result 111 is data generated by the search system 110 that identifies a resource 105 and/or a book that is responsive to a particular search query 109, and can include a link to a resource 105 or a representation of a book. An example search result 111 for a web resources can include a web page title, a snippet of text or an image or portion thereof extracted from the web page, and a hypertext link (e.g., a uniform resource locator (URL)) to the web page. An example search result for a book may include an image of the cover of a book or of a page of the book, information identifying the author of the book, a brief description of the book, and a hypertext link to a web page related to the book, such as a publisher or distributor, and a link to scanned pages of the book.

The user devices 106 receive the search results pages and render the pages for presentation to the users. In response to the user selecting a search result 111 at a user device 106, the user device 106 requests the resource identified by the resource locator included in the search result 111. The web site 104 hosting the resource 105 receives the request for the resource 105 from the user device 106 and provides the resource 105 to the requesting user device 106.

### §2.0 Book Search Operations

As described above, the entity analysis apparatus 120 can identify and/or rank entities, such as book expressions, for referencing as search results, adjusting the scoring of search results, and the like. In some implementations, the entity analysis apparatus 120 determines a reference score for book expressions with respect to a particular query based, at least in part, on results of a web corpus search using the particular query. The entity analysis apparatus 120 can use the reference scores to adjust a ranking of book search results and/or to identify book expressions for referencing as search results.

In some implementations, the search system 110 performs two searches in response to receiving a query directed to books. The system 110 can determine whether a query is directed to books in a variety of ways. For example, in some implementations, the search system 110 determines whether a query is directed to books based on the terms of the query. For example, a query that includes the term “book” or the name of a famous author or famous book may be considered a query directed to books. In some implementations, the search system 110 enables users to explicitly select the corpus of resources to search. For example, the search system 110 may enable the users to select between general web searches, book searches, images searches, etc.

The search system 110 performs a first search for books responsive to the query, for example using the entity resource index 116. The search system 110 may identify books that are responsive to the query based on relevance scores for the books and the query. The relevance scores are a measure of the relevance of the books to the query. For example, a book having a relevance score that is higher than the relevance score of another book is considered more relevant to the query than the other book.

The search system 110 performs a second search for web resources responsive to the query, for example using the web resource index 112. Similar to the first search, the search system 110 may identify resources that are responsive to the query based, at least in part, on relevance scores for the resources and the query. The relevance score for a resource is a measure of the relevance of the resource to the query. For example, the relevance score for a resource may be based on an IR score for the resource and the query.

In some implementations, the second search is directed to resources that have at least one reference to a book expression. For example, in response to receiving a query, the search system 110 can access the web resource index 112 to identify resources having at least one reference to a book expression and at least a threshold relevance score for the query. The search system 110 can also generate, for each identified resource, a list of references to book expressions found in the resource.

For each identified resource, the search system 110 may also identify one or more resource reference scores for each reference to a book expression included in the resource. For example, the search system 110 may identify a confidence score and a topicality score for each reference to a book expression included in the resource. The confidence score is a measure of confidence that the reference actually refers to the book expression. For example, a reference to a book expression that matches the title for the book expression exactly may have a high confidence score. The topicality score is a measure of the topicality relatedness of the book expression to content of the resource. For example, if a web page is dedicated to a particular book expression and includes a substantial amount of content related to that book expression, the web page may have a higher topicality score than a blog of a user that lists books previously read by the user, including a manifestation of the book expression.

The search system 110 provides information that identifies the books and web resources identified in the two searches to the entity analysis apparatus 120. The search system 110 can also provide, for each identified resource, the relevance score for the resource, a list of references to book expressions found in the resource, and one or more resource reference scores for each listed reference. For each identified book, the search system 110 may provide the relevance score for the book.

The entity analysis apparatus 120 can determine a reference score for each reference to a book expression—or for the expression itself—included in the identified resources. A book expression may be referenced in resources in multiple ways. For example, a reference to the English edition of “The Adventures of Tom Sawyer” in a first resource may include the text “The Adventures of Tom Sawyer,” while a reference to the English edition of “The Adventures of Tom Sawyer” in a second resource may include the text “English Edition of the Adventures of Tom Sawyer.” As the two references reference the same book expression, a reference score may be determined for the book expression using data about both references and the resources having those references. In some implementations, the reference score for a book expression may be based on the relevance score for each resource that includes a reference to the book expression, the one or more resource reference scores for each reference to the book expression, and/or a resource partial score for each resource that includes a reference to the book expression.

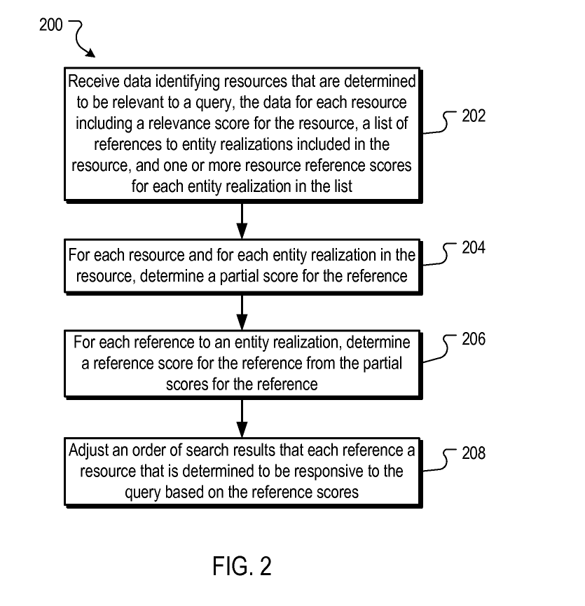

FIG. 2 is a flow chart of an example process 200 for ordering book search results responsive to a search query. The process 200 can be performed by the entity analysis apparatus 120 in conjunction with the search system 110.

Data identifying resources that are determined to be relevant to the query are received (202). As described above, this data may be received from the search system 110 and can include, for each identified resource, the relevance score for the resource, a list of references to book expressions found in the resource, and one or more resource reference scores for each listed reference. Also included with the data may be data identifying books that are determined to be relevant to the query and a relevance score for each identified book.

For each resource, a reference partial score, also referred to herein as a “first partial score,” is determined for each reference to a book expression included in the resource (204). For example, the entity analysis apparatus 120 may determine a reference partial score for each reference to a book expression found in each identified resource. In some implementations, the reference partial scores are resource specific. That is, a reference partial score for a particular reference is specific to the resource in which the reference is found. If the reference is included in multiple identified resources, then multiple reference partial scores may be determined for the reference, one for each resource in which the reference is included.

In some implementations, the reference partial score for a particular reference to a book expression included in a particular resource is based on the relevance score for the particular resource, the one or more resource reference scores for the particular reference with respect to the particular resource (e.g., a confidence score and/or topicality score), and a resource partial score for the particular resource.

The resource partial score, also referred to herein as a “second partial score” for a particular resource can be based on each reference to a book expression included in the particular resource. For example, the resource partial score for the particular resource can be based on a sum of first values, where each first value is for a particular reference in the resource. In some implementations, the first value for a reference in the particular resource is proportional to a product of the confidence score and the topicality score for the reference with respect to the resource.

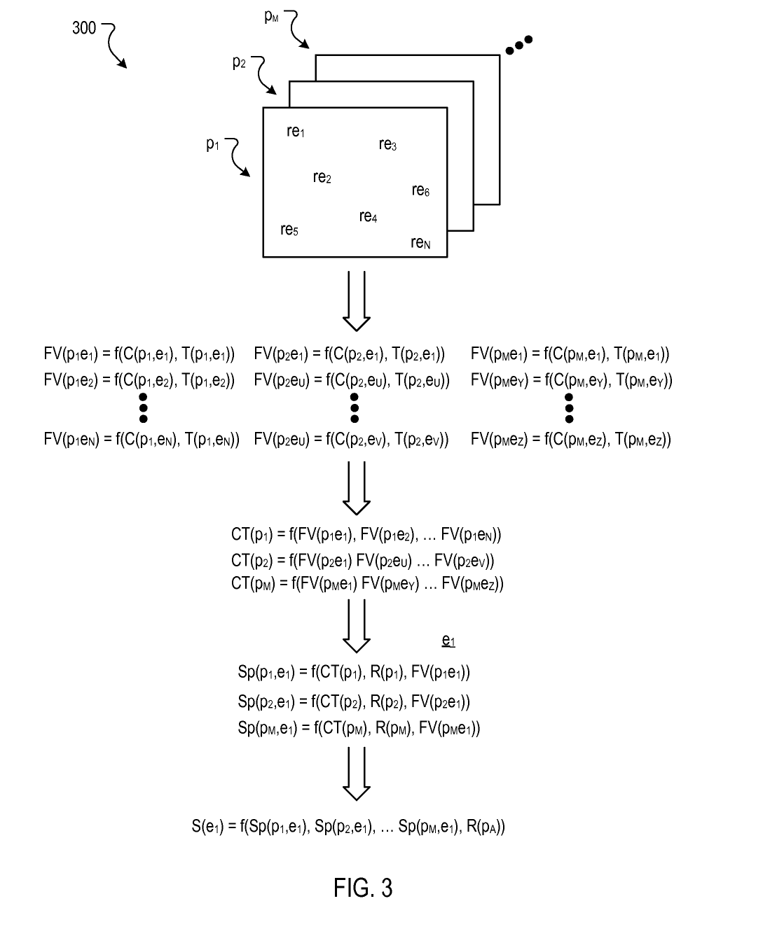

For each reference to a book expression included in the identified resources, a reference score for the reference is determined from the reference partial scores for the reference (206). For example, the entity analysis apparatus 120 can determine the reference score for a reference by combining the reference partial scores for the reference for all resources in which the reference is included. In some implementations, the entity analysis apparatus 120 determines the reference score for a reference by determining a sum or geometric mean of the reference partial scores for the reference. An exemplary process for determining reference partial scores for a reference to a book expression and a reference score for the reference is described below with reference to FIGS. 3 & 4.

An order of search results that each reference a resource that is determined to be responsive to the query is adjusted (208). For example, the books identified by the search system 110 may originally be ordered based on relevance scores for the books with respect to the query. The entity analysis apparatus 120 can use the reference scores for the book expressions to adjust the order of the books and/or to identify other books or book expressions to reference in search results.

An order of search results can be adjusted in a variety of ways. In some implementations, a book identified by the search system 110 may be promoted in the order if a book expression related to the book receives a high reference score. For example, if the book is a manifestation of a book expression having a high reference score, that book may be moved to a higher position in the order. Similarly, a book identified by the search system 110 may be demoted in the order if a book expression related to the book receives a low reference score.

In some implementations, the entity analysis apparatus 120 may adjust the order of the search results based on a relevance score for the books referenced in the search results and the reference scores for the book expressions. For example, the entity analysis apparatus 120 may determine a rank score for each book based on the relevance score for the book and the reference score for a book expression related to the book. The entity analysis apparatus 120 may determine the rank score for a book by summing, multiplying, averaging, or otherwise combining the relevance score for the book with a reference score for a book expression related to the book. The entity analysis apparatus 120 can order the search results based on the rank scores for the books referenced by the search results.

In some implementations, the entity analysis apparatus 120 adjusts the order of the search results by adding additional search results to the order. For example, if a book expression receives at least a threshold reference score and the search system 110 did not identify a book related to the book expression, the entity analysis apparatus 120 may generate a synthetic search result that references the book expression or a manifestation of the book expression. The entity analysis apparatus 120 may place the synthetic search result in the order based on the reference score for the book expression. For example, the reference scores for the book expressions may be normalized or scaled to correspond to the relevance scores for the books. The entity analysis apparatus 120 can order the synthetic search results for book expressions and the identified books based on the reference scores for book expressions of the synthetic search results and the relevance scores for the identified books. For example, a synthetic search result for a book expression having reference score that is higher than the relevance score for an identified book may be placed above the search result for the book in the order.

After adjusting the order of the search results, the entity analysis apparatus 120 can send data specifying the ordered search results to the search system 110. In turn, the search system 110 can provide search results to the user device 106 that submitted the query based on the order. Or, the entity analysis apparatus 120 may be configured to send the search results to the user device 110.

### §2.1 Reference Scoring

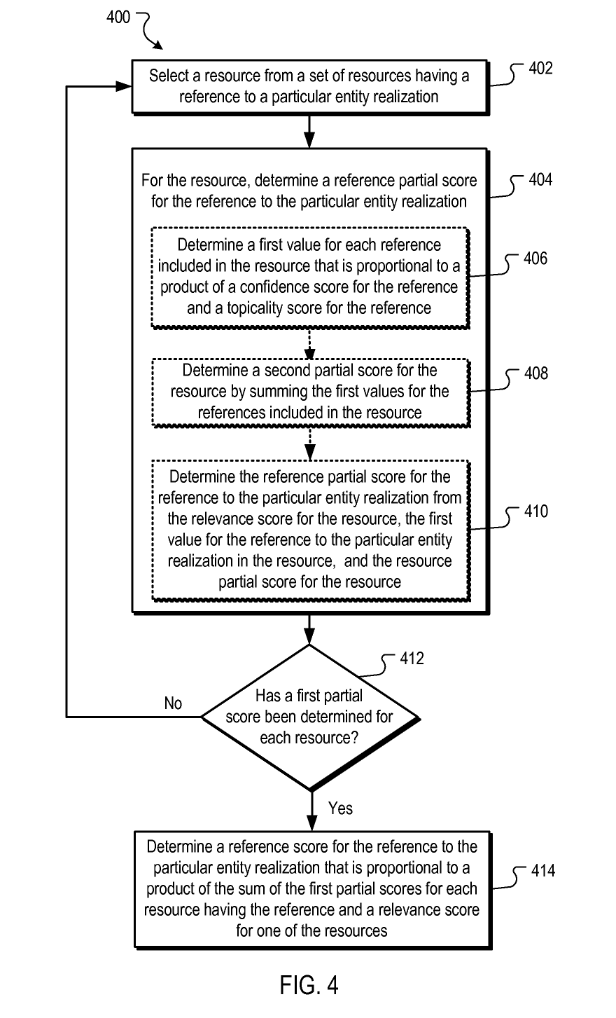

FIG. 3 is a block diagram of an example data flow 300 for determining a reference score for an entity realization, and FIG. 4 is a flow chart of an example process 400 for determining a reference score for an entity realization. FIG. 4 is discussed with reference to FIG. 3 and with reference to a particular book expression entity realization, referred to in FIG. 3 as “e₁.”

A resource from a set of resources having a reference to the book expression e₁ is selected (402). As discussed above, the search system 110 may identify a set of resources responsive to a query and provide information identifying the resources to the entity analysis apparatus 120. Each resource may include at least one reference to a book expression. The provided information may include, for each resource, a relevance score for the resource and the query, a list of references to book expressions included in the resource, and one or more resource reference scores for each reference to a book expression included in the resource.

The entity analysis apparatus 120 may identify a subset of the identified resources that include a reference to the book expression e₁. This subset is illustrated in FIG. 3 as resources p₁-p_{M}. Each individual resource of the subset p₁-p_{M} includes at least one reference re₁ to the book expression e₁. Each resource may also individually reference other references, as indicated by re₂-re_{N} to other book expressions in p₁, such as book expressions e₂-e_{N}.

In some implementations, the resources p₁-p_{M} may also include resources having a reference to a different level of classification for the book expression e₁. For example, the entity analysis apparatus 120 may be configured to identify, for the subset, resources having a reference to a manifestation of the book expression e₁ or a reference to the work related to the book expression e₁. By way of example, if the book expression e₁ is the English edition of “The Adventures of Tom Sawyer” the novel, resources having a reference to the English edition of “The Adventures of Tom Sawyer,” the work “Tom Sawyer,” and/or a large print manifestation of the novel “The Adventures of Tom Sawyer” may be included in the subset. If included in the subset, the entity analysis apparatus 120 may treat references to manifestations and works as references to the book expression related to the manifestation or work.

A reference partial score “SP(p₁,e₁)” is determined for the reference re₁ to the book expression e₁ included in the selected resource p₁. In some implementations, the reference partial score SP(p₁,e₁) is determined from the relevance score “R(p₁)” for the resource p₁ the one or more resource reference scores for the particular reference with respect to the particular resource (e.g., a confidence score “C(p₁,e₁)” and/or topicality score “T(p₁,e₁)”), and a resource partial score “CT(p₁)” for the resource p₁. For example, the reference partial score SP(p₁,e₁) may be determined using constituent operations depicted in blocks 406-408.

A first value “FV” for each reference to a book expression included in the selected resource p₁ is determined (406). For example, the entity analysis apparatus 120 may determine the first value for a reference to a book expression based on the one or more resource reference scores for the reference with respect to the selected resource p₁. In some implementations, the first value FV(p₁e₁) for the reference re₁ to the book expression e₁ found on resource p₁ is determined based on the confidence score C(p₁e₁) for the reference re₁ with respect to the resource p₁ and the topicality score T(p₁,e₁) for the reference re₁ with respect to the resource p₁. For example, the first value for a reference and a resource may be proportional to the product of the confidence score and the topicality score, and, optionally, a constant, for the reference and the resource, as shown in Equation 1 below:

FV(p,e)=C(p,e)*(T(p,e)+0.01) Equation 1:

A first value can be determined for each reference to a book expression included in the selected resource p₁. For example, a first value is determined for each of references re₁-re_{N}, which are included in the selected resource p₁.

A resource partial score CT(p₁) for the selected resource p₁ is determined (408). In some implementations, the entity analysis apparatus 120 determines the resource partial score CT(p₁) based on the first values for the references to book expressions included in the selected resource p₁. For example, the resource partial score CT(p₁) for the selected resource p₁ may be determined based on the first values FV(p₁,e₁)-FV(p₁, e_{M}). The entity analysis apparatus 120 may determine the resource partial score for a resource by summing the first value for each reference to a book expression included in the resource, as shown in Equation 2 below:

CT(p)=ΣC(p,e)*(T(p,e)+0.01) for all book expressions “e” included in resource “p.” Equation 2:

A reference partial score “Sp(p₁, e₁)” for the particular reference re₁ to the book expression e₁ and the resource p₁ is determined (410). The entity analysis apparatus 120 may determine the reference partial score Sp(p₁, e₁) based on the relevance score R(p) for the resource p₁, the first value FV(p₁, e₁) for the reference re₁ and the resource p₁, and the resource partial score CT(p₁) for the selected resource p₁. For example, the entity analysis apparatus 120 may determine the reference partial score Sp(p₁, e₁) using Equation 3 below:

$$Sp ( {p}_{1} , {e}_{1} ) = {( \frac{k 1}{{R ( {p}_{1} )}^{k 2}} * \frac{{FV ( {p}_{1} , {e}_{1} )}^{2}}{CT ( {p}_{1} )} )}^{3} \qquad Equation 3$$

More generally, the reference partial score for a reference to a book expression “e” included in a resource “p” can be determined using Equation 4 below:

$$Sp ( p , e ) = {( \frac{k 1}{{R ( p )}^{k 2}} * \frac{{( C ( p , e ) * ( T ( p , e ) + 0.01 ) )}^{2}}{CT ( p )} )}^{3} \qquad Equation 4$$

In Equations 3 and 4, the parameters k1, k2, and k3 are variable and can be adjusted, for example by a system designer, or learned by the entity analysis apparatus 120.

A determination is made whether a reference partial score has been determined for the reference re₁ for each resource of the subset of resources having a reference re₁ to the book expression e₁ (412). For example, the entity analysis apparatus 120 may determine a reference partial score for each of the resources in order based on the relevance scores for the resources with respect to the query, or in some other order. If the entity analysis apparatus 120 determines that a reference partial score has not been determined for each resource of the proper subset, the entity analysis apparatus 120 can select a resource for which a reference partial score has not been determined from the subset (402).

If the entity analysis apparatus 120 determines that a reference partial score has been determined for the reference re₁ for each resource of the subset of resources p₁-p_{M} that include a reference to the book expression e₁, a reference score “S(e₁)” for the reference re₁ to the book expression e₁ is determined (414). For example, the entity analysis apparatus 120 may determine the reference score S(e₁) based on the reference partial scores Sp(p₁,e₁)-Sp(p_{M},e₁) for the reference re₁ and each resource of the proper subset p₁-p_{M}. The reference score S(e₁) may also be based on a relevance score R(p) for one of the resources of the proper subset p₁-p_{M}.

In some implementations, the entity analysis apparatus 120 combines the reference partial scores Sp(p₁,e₁)-Sp(p_{M},e₁) for the reference re₁ to determine a combined score, for example by summing the reference partial scores Sp(p₁,e₁)-Sp(p_{M},e₁) or determining the geometric mean of the reference partial scores Sp(p₁,e₁)-Sp(p_{M},e₁). To determine the reference score S(e₁) for the reference re₁, the entity analysis apparatus 120 can find the product of the combined score and the relevance score R(p) for the one resource.

In some implementations, the relevance score R(p) used to determine the reference score S(e₁) is the relevance score of the resource in an N^{th} ordinal position when the resources p₁-p_{M} are ordered in a rank according to their respective relevance scores. For example, the N^{th} ordinal position may be the 10^{th} position, the 100^{th} position, the 1000^{th} position, or another position. In some implementations, the relevance score R(p) used to determine the reference score S(e₁) is the IR score for the resource in the N^{th} ordinal position. In some implementations, the relevance score R(p) used to determine the reference score S(e₁) is the ordinal position.

By including the relevance score R(p) for the resource in the reference score computation, the reference score can reflect the quality of the web search results. This can be beneficial in normalizing the reference scores with relevance scores, such as IR scores, for the book search results. For example, this normalization can enable the entity analysis apparatus 120 to better order book search results having an IR score with book expression search results having a reference score.

In some implementations, Equation 5 below is used to determine the reference score S(e) for a reference to a book expression “e”:

S(e)=(ΣSp(p,e) for all p having a reference to e)^{k4}*IRw(10) Equation 5:

where k4 is an adjustable parameter and IRw10 is the IR (or other relevance) score for the resource of the proper subset of resources that include a reference to the book expression “e” in the 10^{th} ordinal position.

### §2.2 Resource Identification Operations for the Web Corpus

As there are many thousands of web sites, there are millions of resources available over the network 102. To facilitate expression scoring and ranking, the entity analysis apparatus 120 can identify a proper subset of the resources and constrain the reference scoring processed described above to the proper subset. The proper subset can include relatively small set of resources (as compared to the resources available over the network 102) that are identified as being relevance to book expressions.

In some implementations, the entity analysis apparatus 120 identifies a proper subset of resources that are relevant to book expressions and interacts with the search system 110 to specify the proper subset in the web resource index 112. In some implementations, the search system 110 accesses the web resource index 112 to identify indexed resources that include a reference to at least one book expression, for example by comparing text included in each resource to a list of known book expressions. The search system 110 may provide data identifying the resources having a reference to at least one book expression to the entity analysis apparatus 120, along with a quality score for each resource. The quality score of a resource is a measure of quality of the resource relative to other resources. In some implementations, the quality score of a resource is a query independent measure of quality. That is, the quality score of a resource may be a measure of quality of the resource relative to other resources irrespective of the query for which the resources were identified.

The search system 110 may also provide, for each resource, one or more resource reference scores for each reference to a book expression included in the resource. The one or more resource reference scores for a reference to a book expression and a resource may include a confidence score that is a measure of confidence that the reference actually references the book expression and/or a topicality score that is a measure of the topicality of the topical relatedness of the book expression to the content of the resource.

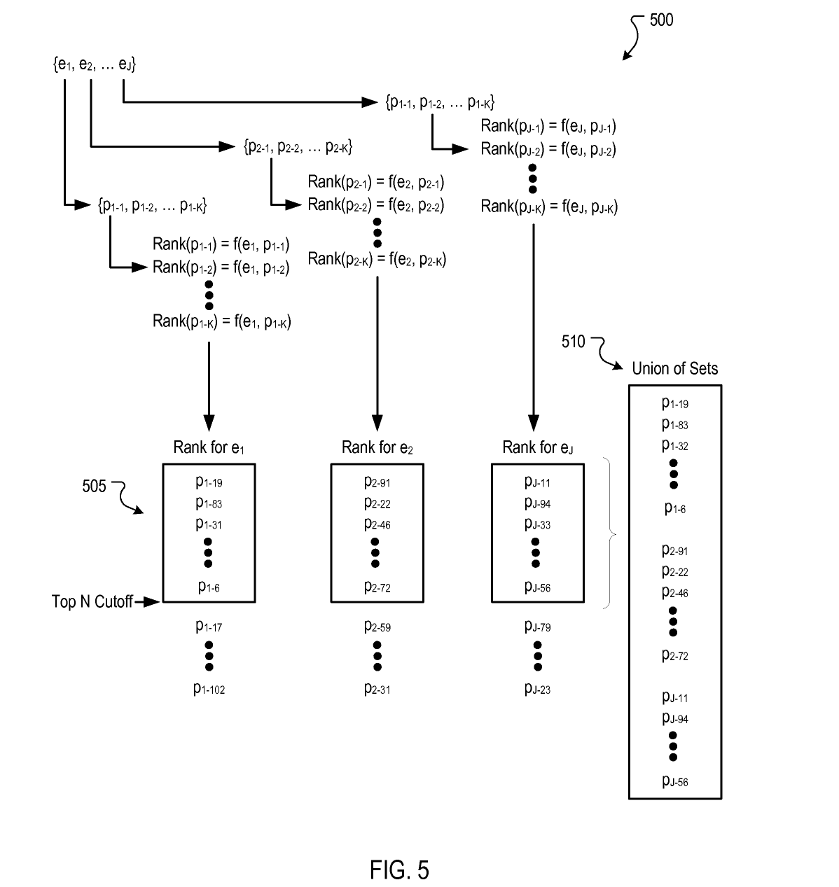

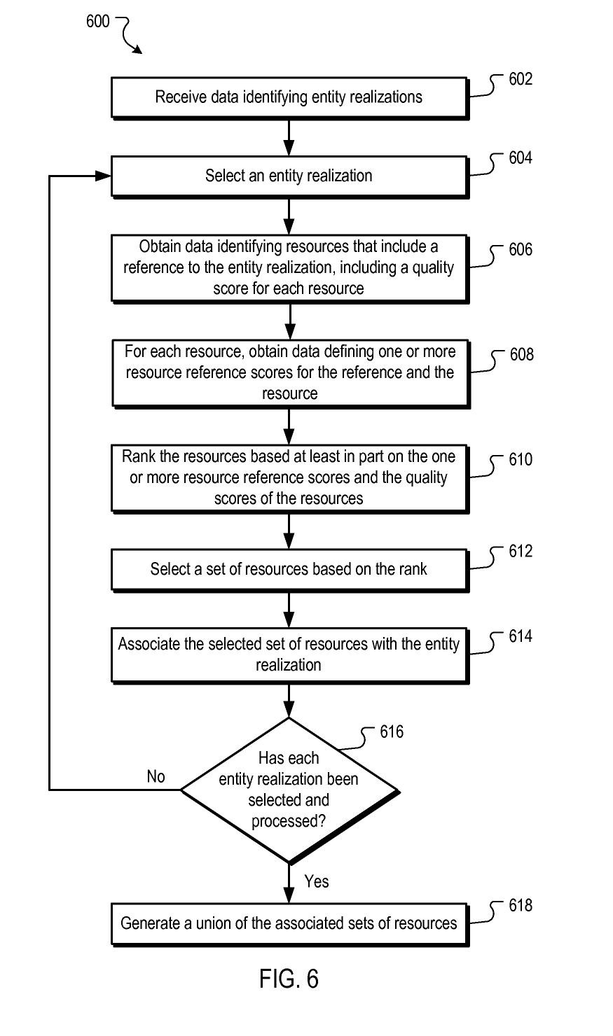

FIG. 5 is a block diagram of an example data flow 500 for identifying set of resources for entity realizations. FIG. 6 is a flow chart of an example process 600 for identifying a set of resources for entity realizations. FIG. 6 is discussed with reference to the example illustrated in FIG. 5 and with reference to book expression entity realizations.

Data identifying book expressions e₁-e_{J} are received (602). For example, the entity analysis apparatus 120 may receive data identifying book expressions e₁-e_{J} from the search system 110, as mentioned above. In some implementations, the search system 110 may maintain a list of known book expressions, for example in the entity resource index 116. Or, a system designer or administrator may provide a list of book expressions to the search system 110 or the entity analysis apparatus 120.

A book expression e₁ from the identified book expressions e₁-e_{J} is selected (604). For example, the entity analysis apparatus 120 may select one of the book expressions e₁-e_{J} pseudo-randomly or based on a predefined order.

Data identifying resources that include a reference to the selected book expression is obtained (606). For example, the entity analysis apparatus 120 may receive data identifying resources p₁₋₁-p_{1-K} that each includes a reference to the selected book expression e₁ from the search system 110. In some implementations, the search system 110 accesses the web resource index 112 to identify resources that include a reference to at least one of the book expressions e₁-e_{J} and provides data identifying those resources to the entity analysis apparatus 120. This data may also include, for each resource, a list of book expressions referenced by the resource.

In addition to the data identifying the resources p₁₋₁-p₁₋ₖ that include a reference to the selected book expression e₁, the entity analysis apparatus 120 may also receive a quality score for each resource p₁₋₁-p₁₋ₖ, for example from the search system 110. The quality score for a resource is a measure of the quality of the resource relative to other resources. For example, the quality score may be an authority rank score for the resource relative to other resources.

For each resource p₁₋₁-p₁₋ₖ that includes a reference to the selected book expression e₁, data defining one or more resource reference scores for the resource and the selected book expression e₁ is received (608). For example, the entity analysis apparatus 120 may receive the data defining the resource reference scores from the search system 110. The one or more resource reference scores for each resource p₁₋₁-p_{1-K} may include a confidence score that is a measure of confidence that the reference to the book expression included in the resource actually references the book expression. The one or more resource reference scores for each resource p₁₋₁-p₁₋ₖ may include a topicality score that is a measure of the topical relatedness of the book expression referenced in the resource to content of the resource.

The resources p₁₋₁-p₁₋ₖ that include a reference to the selected book expression are ranked for the book expression based, at least in part, on the quality scores for the resources and the one or more resource reference scores for the resources (610). In some implementations, the entity analysis apparatus 120 computes a rank score for each resource based on the quality score for the resource and the one or more resource reference scores for the resource with respect to the book expression. The entity analysis apparatus 120 can then order the resources p₁₋₁-p₁₋ₖ based on the rank scores.

In some implementations, the rank score for a resource is proportional to the product of the one or more resource reference scores and the quality score for the resource. For example, the rank score for a resource with respect to a particular book expression e₁ may be proportional to a product of the quality score for the resource and the confidence score for the resource and the reference to the particular book expression e₁ included in the resource. By way of another example, the rank score for a resource with respect to a particular book expression e₁ may be proportional to a product of the quality score for the resource and the topicality score for the resource and the reference to the particular book expression e₁ included in the resource. By way of yet another example, the rank score for a resource with respect to a particular book expression e₁ may be proportional to a product of the quality score for the resource, the confidence score for the resource and the particular book expression e₁, and the topicality score for the resource and the particular book expression e₁.

For implementations that include a rank score based on the quality score and the confidence score, without considering the topicality score, the subset of web resources may be more generically appropriate as opposed to those that are entirely directed to a given book. For example, for the expression “Tom Sawyer,” it may be desirable to provide search results for book review or rating web sites, such as the New York Time's Best Sellers List, although such a web site may not be the most topical. Such a web site may receive a high quality score and a high confidence score, but may receive a low topicality score. If the topicality score is included in the rank score, then the web site may be excluded from the proper subset and thus, not scored by the entity analysis apparatus 120 at query time.

A set of resources are selected for the selected book expression e₁ based on the rank (612). For example, the entity analysis apparatus 120 may select the top “N” ranked resources for the book expression e₁. The number “N” can be any number, such as 10, 100, or 1000. As shown in FIG. 5, the resources in block 505 for the book expression e₁ are selected as they are ranked above the cutoff, while the resources below the block 505, such as resource p₁₋₁₇, are not selected as those resources are ranked below the cutoff. In some implementations, rather than selected the top “N” ranked resources, the entity analysis apparatus 120 selects each resource having a rank score above a threshold, such as a threshold set by a system designer or administrator.

The set of resources selected for the selected book expression is associated with the selected entity realization (614). For example, the entity analysis apparatus 120 may interact with the search system 110 to generate an index in the web resource index 112 that maps resources to book expressions. For the example book expression e₁, the resources included in the block 505 may be mapped to the book expression e₁ in the index.

A determination is made whether each book expression e₁-e_{J} has been selected and processed (616). For example, the entity analysis apparatus 120 may determine whether each book expression e₁-e_{J} identified in the received data has been processed to identify the top “N” resources for the book expression e₁-e_{J}. If the entity analysis apparatus 120 determines that each book expression has not been processed, another book expression is selected (604). For example, the book expression e₂ or e_{J} may be selected and processed to identify the top “N” resources for that book expression.

If the entity analysis apparatus 120 determines that each of the book expressions e₁-e_{J} has been processed, the entity analysis apparatus 120 generates a union of the associated sets of resources. For example, the entity realization apparatus 120 may create a group that includes the top “N” resources for each of the identified book expressions e₁-e_{J}. As shown in FIG. 5, a union of sets 510 includes the top “N” resources for the book expressions e₁-e_{J}.

In some implementations, the selection of resources for each book expression is not constrained to disjoint sets. Thus, any two sets of selected resources for any two book expressions may intersect. For example, a resource selected for a first book expression may also be selected for a second book expression different than the first book expression.

In some implementations, a union of the selected resources for all book expressions defines the proper subset of resources for the web corpus. That is, the first index of resources 112 may include data specifying the resources of the union.

### §3.0 Additional Example Implementations

As described above, the systems and processes described herein can be used to identify, score, and/or rank many types of entities, such as movies, plays, music, people, television programs, and television episodes, to name a few examples. To rank people in response to a query using the processes described above, the search system 110 can identify resources that are responsive to the query and use information regarding the resources and references to people's names included in the resources.

For example, a query for famous sports figures may surface various web pages that each includes a reference to one or more sports figures and possibly references to other people. The search system 110 can identify each reference to a person included in each resource, for example by comparing names of people included in an index of people names to the contents of each resource. For each identified resource, the search system 110 can provide to the entity analysis apparatus 120 a relevance score for the resource, a list of references to a person name included in the resource, and for each reference to a person name in the resource, a confidence score and a topicality score. The confidence score is a measure of confidence that the reference actually refers to the named person and the topicality score is a measure of the topical relatedness of the named person to the content of the resource. For example, consider a football player “Joe Player.” A topicality score for a reference to Joe Player that is included in an official fan page devoted to Joe Player may be higher than the topicality score for a reference to Joe Player that is included in a web page that lists starting quarterbacks in a football league. A confidence score for a reference “Joe Player is listed as the starting quarterback this week . . . ” may be higher than the confidence score for a reference that includes the name Joe Player but does not include content related to football.

To rank the people referenced in the resources including the sports figures, the entity analysis apparatus 120 can perform the processes described above using the data received from the search system 110. In particular, the entity analysis apparatus 120 can determine a reference score for each person referenced in at least one of the resources and rank the people based on the reference scores. Similar to the reference scores for book expressions, the reference score for a person can be based on a sum of reference partial scores for the person, where each reference partial score for the person is determined with respect to a particular resource that includes a reference to the person. For example, the reference score for each person can be determined using Equations 1-5 described above.

### §4.0 Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
a processing apparatus;
a memory storage apparatus in data communication with the data processing apparatus, the memory storage apparatus storing instructions executable by the data processing apparatus and that upon such execution cause the data processing apparatus to perform operations comprising:
receiving data identifying resources that are determined to be relevant to a query, the data including, for each resource:
a relevance score that is a measure of relevance of the resource to the query;
a list of references to entity realizations included in the resource, each reference being a reference to a particular entity realization; and
for each reference to an entity realization in the list, one or more resource reference scores that are a measure of a quality of the reference in a context of the resource;
for each resource and for each reference to an entity realization in the resource, determining a first partial score for the reference from the one or more resource reference scores for the reference and the relevance score for the resource;
for each reference to an entity realization, determining a reference score for the reference from each of the first partial scores for the reference; and
adjusting an order of search results that each reference a resource that is determined to be responsive to the query based on reference scores.

2. The system of claim 1, wherein each entity realization is an expression, the expression being a specific intellectual or artistic form of a realization of a distinct intellectual creation.

3. The system of claim 2, wherein the determining the first partial score for the reference from the one or more resource reference scores for the reference and the relevance score for the resource comprises:
determining, for the resource, a second partial score from one or more resource reference scores of each reference included in the resource; and
determining, for the reference, the first partial score from the one or more resource reference scores for the reference, the relevance score for the resource, and the second partial score for the resource.

4. The system of claim 3, wherein:
for each reference, the one or more resource reference scores include:
a confidence score that is a measure of confidence that the reference actually references the expression; and
a topicality score that is a measure of the topical relatedness of the expression to content of the resource;
determining, for the resource, the second partial score from one or more resource reference scores of each reference included in the resource comprises:
for each reference included in the resource, determining a first value proportional to a product of the confidence score and the topicality score; and
summing the first values determined for each reference included in the resource.

5. The system of claim 4, wherein determining, for the reference, the first partial score from the one or more resource reference scores for the reference, the relevance score for the resource, and second partial score for the resource comprises:
determining, for the reference, a second value proportional to the first value divided by the relevance score for the resource; and
determining, for the reference, the first partial score in proportion to the second value divided by the second partial score.

6. The system of claim 5, wherein determining the reference score for the reference from each of the first partial scores for the reference comprises:
summing the first partial scores determined for the reference for each of the resources that include the reference; and
determining the reference score in proportion to a product of the sum of the first partial scores and a relevance score of one of the resources.

7. The system of claim 6, wherein the relevance score of one of the resources is a relevance score of a resource in an Nth ordinal position when the resources are ordered in a rank according to their respective relevance scores.

8. The system of claim 7, wherein the relevance score is the ordinal position.

9. The system of claim 3, wherein:
determining, for the reference, the first partial score from the one or more resource reference scores for the reference, the relevance score for the resource, and second partial score for the resource comprises:
for each reference included in the resource, determining a first value proportional to the one or more resource reference scores; and
summing the first values determined for each reference included in the resource.

10. The system of claim 9, wherein determining the reference score for the reference from each of the first partial scores for the reference comprises:
summing the first partial scores determined for the reference for each of the resources that include the reference; and
determining the reference score in proportion to a product of the sum of the first partial scores and a relevance score of one of the resources.

11. The system of claim 10, wherein the relevance score of one of the resources is a relevance score of a resource in an Nth ordinal position when the resources are ordered in a rank according to their respective relevance scores.

12. The system of claim 1, wherein each entity realization is a name of a person.

13. A method performed by a data processing apparatus, the method comprising:
receiving data identifying resources that are determined to be relevant to a query, the data including, for each resource:
a relevance score that is a measure of relevance of the resource to the query;
a list of references to entity realizations included in the resource, each reference being a reference to a particular entity realization; and
for each reference to an entity realization in the list, one or more resource reference scores that are a measure of a quality of the reference in a context of the resource;
for each resource and for each reference to an entity realization in the resource, determining a first partial score for the reference from the one or more resource reference scores for the reference and the relevance score for the resource;
for each reference to an entity realization, determining a reference score for the reference from each of the first partial scores for the reference; and
adjusting an order of search results that each reference a resource that is determined to be responsive to the query based on reference scores.

14. The method of claim 13, wherein each entity realization is an expression, the expression being a specific intellectual or artistic form of a realization of a distinct intellectual creation.

15. The method of claim 14, wherein the determining the first partial score for the reference from the one or more resource reference scores for the reference and the relevance score for the resource comprises:
determining, for the resource, a second partial score from one or more resource reference scores of each reference included in the resource; and
determining, for the reference, the first partial score from the one or more resource reference scores for the reference, the relevance score for the resource, and the second partial score for the resource.

16. The method of claim 15, wherein:
for each reference, the one or more resource reference scores include:
a confidence score that is a measure of confidence that the reference actually references the expression; and
a topicality score that is a measure of the topical relatedness of the expression to content of the resource;
determining, for the resource, the second partial score from one or more resource reference scores of each reference included in the resource comprises:
for each reference included in the resource, determining a first value proportional to a product of the confidence score and the topicality score; and
summing the first values determined for each reference included in the resource.

17. The method of claim 16, wherein determining, for the reference, the first partial score from the one or more resource reference scores for the reference, the relevance score for the resource, and second partial score for the resource comprises:
determining, for the reference, a second value proportional to the first value divided by the relevance score for the resource; and
determining, for the reference, the first partial score in proportion to the second value divided by the second partial score.

18. The method of claim 17, wherein determining the reference score for the reference from each of the first partial scores for the reference comprises:
summing the first partial scores determined for the reference for each of the resources that include the reference; and
determining the reference score in proportion to a product of the sum of the first partial scores and a relevance score of one of the resources.

19. The method of claim 15, wherein:
determining, for the reference, the first partial score from the one or more resource reference scores for the reference, the relevance score for the resource, and second partial score for the resource comprises:
for each reference included in the resource, determining a first value proportional to the one or more resource reference scores; and
summing the first values determined for each reference included in the resource.

20. A computer storage medium encoded with a computer program, the program comprising instructions that when executed by a data processing apparatus cause the data processing apparatus to perform operations comprising:
receiving data identifying resources that are determined to be relevant to a query, the data including, for each resource:
a relevance score that is a measure of relevance of the resource to the query;
a list of references to entity realizations included in the resource, each reference being a reference to a particular entity realization; and
for each reference to an entity realization in the list, one or more resource reference scores that are a measure of a quality of the reference in a context of the resource;
for each resource and for each reference to an entity realization in the resource, determining a first partial score for the reference from the one or more resource reference scores for the reference and the relevance score for the resource;
for each reference to an entity realization, determining a reference score for the reference from each of the first partial scores for the reference; and
adjusting an order of search results that each reference a resource that is determined to be responsive to the query based on reference scores.
